(19) United States
(12) Patent Application Publication
(10) Pub. No.: US 2025/0018549 A1
(43) Pub. Date: Jan. 16, 2025

(54) POWER TOOL AND AUXILIARY HANDLE THEREFOR

(71) Applicant: MILWAUKEE ELECTRIC TOOL CORPORATION, Brookfield, WI (US)

(72) Inventors: Travis P. Gilmour, Milwaukee, WI (US); Devin C. Albrecht, Hartford, WI (US); Brian Callen, Wauwatosa, WI (US); Michael J. Duenk, Waukesha, WI (US)

(21) Appl. No.: 18/767,372

(22) Filed: Jul. 9, 2024

Related U.S. Application Data
(60) Provisional application No. 63/512,808, filed on Jul. 10, 2023.

(51) Int. Cl. B25F 5/02; B25F 5/00

(52) U.S. Cl. CPC B25F 5/024; B25F 5/001

(57) ABSTRACT

A power tool includes a housing, a motor disposed within the housing and operable to drive an output spindle, a main handle graspable by a user to maneuver the power tool, a handle aperture extending through at least a portion of the housing, and an auxiliary handle selectively coupled to the housing via a quick-disconnect mechanism. The auxiliary handle is at least partially insertable into the handle aperture.

### CROSS-REFERENCE TO RELATED APPLICATION

This application claims priority to prior-filed U.S. Provisional Patent Application No. 63/512,808, filed on Jul. 10, 2023, the entire content of which is incorporated herein by reference.

### FIELD OF THE DISCLOSURE

The present invention relates to power tools, and more specifically to drill drivers.

### BACKGROUND OF THE DISCLOSURE

Various power tools, such as drill drivers, rotary hammer, and right-angle grinders, often incorporate an auxiliary handle for a user to grasp to provide additional stability and support while operating the power tool. The auxiliary handle may be removeable from the power tool.

### SUMMARY

The present disclosure provides, in one aspect, a power tool including: a housing; a motor disposed within the housing and operable to drive an output spindle; a main handle graspable by a user to maneuver the power tool; a handle aperture extending through at least a portion of the housing; and an auxiliary handle selectively coupled to the housing via a quick-disconnect mechanism, the auxiliary handle being at least partially insertable into the handle aperture.

The present disclosure provides, in another aspect, an auxiliary handle for a power tool having a main handle, the power tool including a handle aperture for receiving the auxiliary handle, the auxiliary handle including: a grip; and a quick-disconnect mechanism configured to selectively couple the auxiliary handle to the power tool, the quick-disconnect mechanism including a sleeve, a pin disposed within the sleeve and slidable relative to the sleeve along an auxiliary handle axis between a retracted position and an extended position, a ball disposed within a ball aperture in the sleeve, the ball being movable in a radial direction relative to the auxiliary handle axis, and an actuator operable to move the pin between the retracted position and the extended position, wherein the ball is receivable within a groove of the handle aperture to couple the auxiliary handle to the power tool when the pin is in the retracted position.

The present disclosure provides, in another aspect, a power tool including a housing, a motor disposed within the housing, a main handle graspable by a user to maneuver the power tool, and an auxiliary handle selectively coupled to the housing via a quick-disconnect mechanism. The quick-disconnect mechanism includes a sleeve, a pin disposed within the sleeve and slidable relative to the sleeve along an auxiliary handle axis between a retracted position and an extended position, a ball disposed within a ball aperture in the sleeve, the ball being movable in a radial direction relative to the auxiliary handle axis, and an actuator operable to move the pin between the retracted position and the extended position. The ball is receivable within a groove of the housing to couple the auxiliary handle to the power tool when the pin is in the retracted position.

Other features and aspects of the invention will become apparent by consideration of the following detailed description and accompanying drawings.

### BRIEF DESCRIPTION OF THE DRAWINGS

FIG. 1 is a partially exploded view of a power tool in accordance with an embodiment of the invention, illustrating a main handle and an auxiliary handle removably coupled to the power tool.

FIG. 2 is a perspective view of a gear case of the power tool of FIG. 1, illustrating an aperture in the gear case that receives the auxiliary handle.

FIG. 3 is a cross-sectional view of the gear case and the auxiliary handle along line 3-3 of FIG. 2, illustrating a quick-release mechanism.

FIG. 4 is a cross-sectional view of the gear case and the auxiliary handle of FIG. 3, illustrating the auxiliary handle coupled to the gear case.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

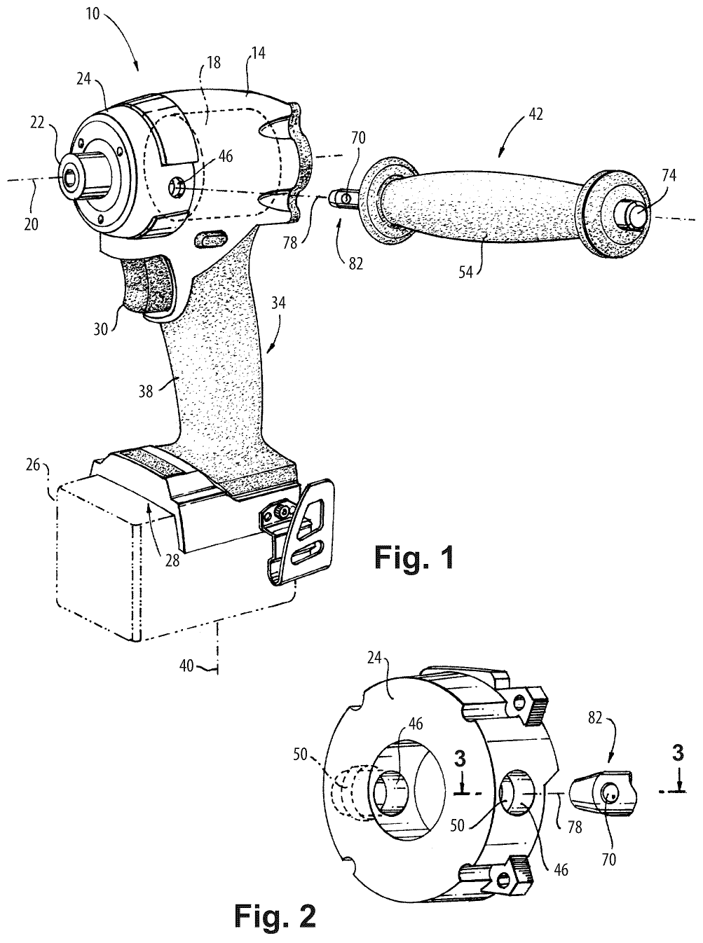

FIG. 1 illustrates a power tool, and, more specifically, a rotary power tool 10 (e.g., a drill driver) including a main housing 14, a motor 18 positioned within the main housing 14, and an output spindle 22 driven by the motor 18 about a drive axis 20. The main housing 14 includes a gear case 24 from which the output spindle 22 extends. Although not shown, a tool bit may be secured to the spindle 22 for performing work on a workpiece. In the illustrated embodiment, the motor 18 is a brushless direct-current electric motor while, in other embodiments, the motor 18 may alternatively be a brushed electric motor. A battery 26 supplies power to the motor 18 when a user depresses a trigger 30. The battery 26 may be removably received within a battery receptacle 28 that is adjacent a main handle 34. Also, the trigger 30 is disposed adjacent a gripping region 38 of the main handle 34.

With continued reference to FIG. 1, the main handle 34 defines main handle axis 40 that is generally perpendicular to the drive axis 20 of the output spindle 22. In other, embodiments, the power tool 10 may be, for example, a rotary hammer drill having a D-shaped handle, which also has a gripping region defining a handle axis that is generally perpendicular to the drive axis 20.

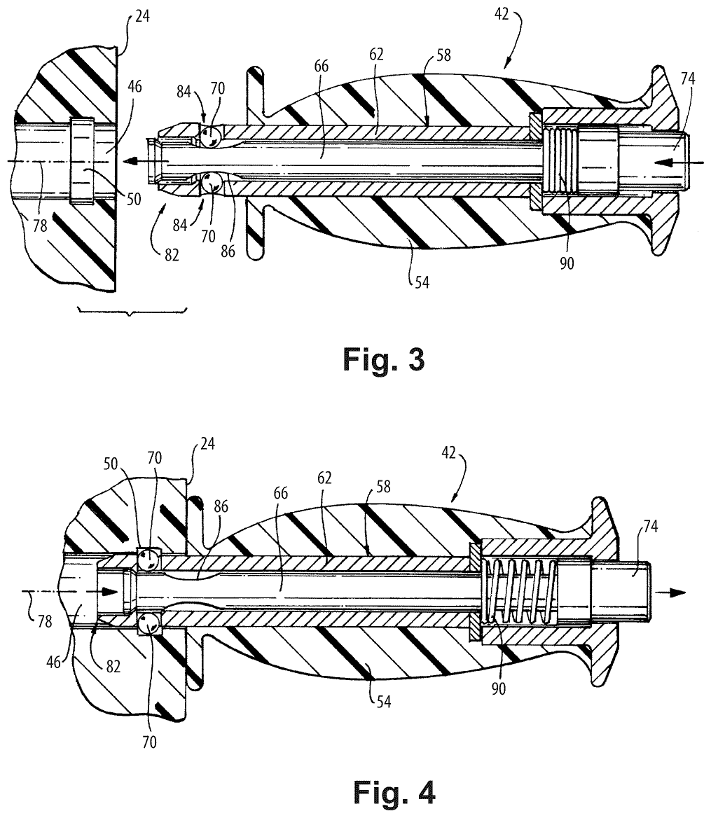

With reference to FIGS. 1-3, the rotary power tool 10 further includes an auxiliary handle 42 that is selectively coupled to the power tool 10. Specifically, the auxiliary handle 42 is received in a handle aperture 46 disposed on the gear case 24 and may be removably coupled to the power tool 10. The handle aperture 46 includes a circumferential groove 50 (FIG. 2) that extends radially outward relative to the aperture 46. That is, the groove 50 extends circumferentially 360 degrees. As shown in FIG. 2, the gear case 24 includes the handle aperture 46 on each side, such that the auxiliary handle 42 may be inserted on the left side of the main housing 14 or the right side of the main housing 14 for ease of use for right-handed users, left-handed users, or tight spaces. In other words, there is one handle aperture 46 on one side of the drive axis 20 and there is another handle aperture 46 on an opposite side of the drive axis 20. In other embodiments, only a single handle aperture 46 may be provided, or a different number of handle apertures 46 may be included at various locations on the main housing 14 where it may be desirable to attach the auxiliary handle 42. As described in greater detail below, the auxiliary handle 42 includes a grip 54 and a quick-disconnect mechanism 58 (FIG. 3) that enables the auxiliary handle 42 to be removably coupled to the handle aperture 46, without the use of tools.

With continued reference to FIGS. 1-3, the illustrated quick-disconnect mechanism 58 includes a sleeve 62, a pin 66 slidably received within the sleeve 62, a set of balls 70, and an actuator 74 capable of moving the pin 66 along an auxiliary handle axis 78. The grip 54 of the auxiliary handle 42 is disposed around at least a portion of the sleeve 62, as shown in FIG. 3. Specifically, the grip 54 surrounds the sleeve 62 except for a distal end 82 of the sleeve 62 extending beyond the grip 54. The set of balls 70 are disposed at the distal end 82 of the sleeve 62, such that the set of balls 70 are exposed. The set of balls 70 are configured to move radially outward relative to the sleeve 62 in a direction perpendicular to the auxiliary handle axis 78, as explained in further detail below. The sleeve 62 limits movement of the set of balls 70. Specifically, the set of balls 70 may extend partially beyond the outer periphery of the sleeve 62 (i.e., stand proud, past flush, etc.) without falling out of the sleeve 62. That is, the set of balls 70 are received within ball apertures 84 of the sleeve 62 that are sized to maintain the set of balls 70 in the sleeve 62. In other words, the ball apertures 84 define a diameter that is slightly smaller than a diameter of the balls 70, such that a portion of each ball 70 can extend through the aperture 84 while also inhibiting the balls 70 from passing completely through the apertures 84.

With reference to FIG. 3, the quick-disconnect mechanism 58 is moveable between a locked position (as shown in solid lines), in which the pin 66 is retracted and the set of balls 70 are forced radially outward via the pin 66, and an unlocked position (as shown in phantom lines), in which the pin 66 is extended and the set of balls 70 may move radially inward into a recess 86 of the pin 66. When the set of balls 70 are force radially outward, the set of balls 70 are past flush relative to an outer periphery of the sleeve 62. In contrast, when the set of balls 70 move radially inward, the set of balls 70 are either flush or sub-flush relative to an outer periphery of the sleeve 62. The recess 86 is not aligned (i.e., offset) with the set of balls 70 when the pin 66 is retracted and the recess 86 is aligned (i.e., adjacent) with the set of balls 70 when the pin 66 is extended.

That said, the set of balls 70 are passive objects, meaning that an external force (e.g., gravity, mechanical interferences with the handle aperture 46, etc.) applied to the set of balls 70 move the balls into the recess 86 when the recess 86 is adjacent the set of balls 70. In contrast, the balls 70 move outward when recess 86 is no longer aligned with the balls 70 and the pin 66 mechanically interferes with and exerts a force on the set of balls 70. The actuator 74 extends and retracts the pin 66 along the auxiliary handle axis 78. The recess 86 extends circumferentially inward relative to the pin 66 and is configured to receive at least a portion of each ball 70 when the recess 86 aligns with the set of balls 70. The quick-disconnect mechanism 58 includes a biasing member 90 (i.e., compression spring) that biases the quick-disconnect mechanism 58 toward the locked position. The biasing member 90 exerts a biasing force on the actuator 74, such that the actuator 74 extends outward from the grip 54 along the auxiliary handle axis 78. As such, the biasing member 90 biases the pin 66 toward the retracted position. A user may depress the actuator 74 by exerting a force on the actuator 74 sufficient to overcome the bias of the biasing member 90. Movement of the actuator 74 coincides with movement of the pin 66.

To install the auxiliary handle 42, a user depresses the actuator 74, thereby moving the quick-disconnect mechanism 58 to the unlocked position and extending the pin 66 where the recess 86 aligns with the set of balls 70. The distal end 82 of the sleeve 62 is then inserted into the handle aperture 46, at which point the handle aperture 46 exerts a force on the set of balls 70 that moves the set of balls 70 move radially inward to be received within the recess 86. With the distal end 82 received in the handle aperture 46, a user may release the actuator 74 to move the quick-disconnect mechanism 58 to the locked position. As a result, the pin 66 retracts and the recess 86 no longer aligns with the set of balls 70. The pin 66 forces the set of balls 70 (via mechanical interference) radially outward into the groove 50 of the handle aperture 46. When the set of balls 70 are engaged with the groove 50, the auxiliary handle 42 is axially locked and coupled to the gear case 24, until the actuator 74 is depressed again. However, the auxiliary handle 42 is not rotationally locked and free to rotate 360 degrees about the auxiliary handle axis 78 when coupled to the gear case 24 because the groove 50 extends circumferentially 360 degrees. If the actuator 74 is not depressed, the set of balls 70 mechanically interfere with the gear case 24 (i.e., the groove 50) of the power tool 10 because the set of balls 70 extend radially outward beyond the diameter of the handle aperture 46, thereby inhibit the auxiliary handle 42 from moving along the auxiliary handle axis 78. Once installed, the auxiliary handle axis 78 is perpendicular to the main handle axis 40.

One advantage to the quick-disconnect mechanism 58 on the auxiliary handle 42 is the ease and speed at which the auxiliary handle 42 can be coupled to and removed from the power tool 10, as compared to the slow process of threading and unthreading an auxiliary handle to a power tool, or threading and unthreading a set screw or the like. In addition, the quick-disconnect mechanism 58 facilitates attachment of the auxiliary handle 42 at multiple different points on the main housing 14 (e.g., right and left sides).

Although the disclosure has been described in detail with reference to certain preferred embodiments, variations and modifications exist within the scope and spirit of one or more independent aspects of the disclosure as described.

Various features and advantages of the disclosure are set forth in the following claims.

What is claimed is:

1. A power tool comprising:
a housing;
a motor disposed within the housing and operable to drive an output spindle;
a main handle graspable by a user to maneuver the power tool;
a handle aperture extending through at least a portion of the housing; and
an auxiliary handle selectively coupled to the housing via a quick-disconnect mechanism, the auxiliary handle being at least partially insertable into the handle aperture.

2. The power tool of claim 1, wherein the quick-disconnect mechanism includes
a sleeve insertable into the handle aperture,
a pin disposed within the sleeve and axially slidable within the sleeve along an auxiliary handle axis between an extended position and a retracted position,
a ball disposed within a ball aperture in the sleeve, the ball being movable in a radial direction relative to the auxiliary handle axis, and
an actuator operable to move the pin between the extended position and the retracted position.

3. The power tool of claim 2, wherein the ball is moved radially outward when the pin is in the retracted position and the ball is aligned with a recess when the pin is in the extended position, allowing the ball to move radially inward.

4. The power tool of claim 2, further comprising a biasing member configured to bias the actuator to extend outward from a grip of the auxiliary handle.

5. The power tool of claim 2, wherein the ball is receivable within a groove of the handle aperture when the sleeve is inserted into the handle aperture, thereby coupling the auxiliary handle to the power tool.

6. The power tool of claim 1, further comprising a gear case coupled to the housing, and wherein the handle aperture extends through the gear case.

7. The power tool of claim 6, wherein the output spindle is disposed within the gear case and rotates about a drive axis, wherein the handle aperture is a first handle aperture disposed on one side of the drive axis, and wherein the power tool further includes a second handle aperture extending through the gear case on an opposite side of the drive axis.

8. The power tool of claim 7, wherein the auxiliary handle is insertable into either the first handle aperture or the second handle aperture along an auxiliary handle axis of the auxiliary handle that extends along a direction that is perpendicular to the first axis.

9. The power tool of claim 8, wherein the main handle defines a third axis extends along a direction that is perpendicular to the first axis and the second axis.

10. An auxiliary handle for a handheld power tool having a main handle, the power tool including a handle aperture for receiving the auxiliary handle, the auxiliary handle comprising:
a grip; and
a quick-disconnect mechanism configured to selectively couple the auxiliary handle to the power tool, the quick-disconnect mechanism including
a sleeve,
a pin disposed within the sleeve and slidable relative to the sleeve along an auxiliary handle axis between a retracted position and an extended position,
a ball disposed within a ball aperture in the sleeve, the ball being movable in a radial direction relative to the auxiliary handle axis, and
an actuator operable to move the pin between the retracted position and the extended position,
wherein the ball is receivable within a groove of the handle aperture to couple the auxiliary handle to the power tool when the pin is in the retracted position.

11. The auxiliary handle of claim 10, wherein the quick-disconnect mechanism further includes a biasing member configured to bias the actuator to extend outward from the grip, moving the pin to the retracted position.

12. The auxiliary handle of claim 11, wherein the biasing member biases the pin to the retracted position.

13. The auxiliary handle of claim 10, wherein the quick-disconnect mechanism is moveable between a locked position, in which the pin is in the retracted position and the ball is forced radially outward due to mechanical interference with the pin, and an unlocked position, in which the pin is in the extended position and the ball is aligned with a recess in the pin, allowing the ball to move radially inward.

14. The auxiliary handle of claim 13, wherein a distal end of the sleeve is receivable in the handle aperture when the quick-disconnect mechanism is in the unlocked position, at which point the handle aperture exerts a force on the ball to move the ball radially inward into the recess.

15. The auxiliary handle of claim 10, wherein the ball is past flush relative to the sleeve when the pin is in the retracted position, and wherein the ball is at least flush relative to the sleeve when the pin is in the extended position.

16. The auxiliary handle of claim 10, further including an auxiliary handle axis along which the pin moves between the extended position and the retracted position.

17. The auxiliary handle of claim 16, wherein the auxiliary handle axis is perpendicular to a main handle axis of the main handle when the auxiliary handle is received within the handle aperture.

18. The auxiliary handle of claim 16, wherein when the auxiliary handle is coupled to the power tool, the auxiliary handle is free to rotate about the auxiliary handle axis without translating along the auxiliary handle axis.

19. The auxiliary handle of claim 16, wherein the actuator moves along the auxiliary handle axis.

20. A power tool comprising:
a housing;
a motor disposed within the housing;
a main handle graspable by a user to maneuver the power tool; and
an auxiliary handle selectively coupled to the housing via a quick-disconnect mechanism, the quick-disconnect mechanism including
a sleeve,
a pin disposed within the sleeve and slidable relative to the sleeve along an auxiliary handle axis between a retracted position and an extended position,
a ball disposed within a ball aperture in the sleeve, the ball being movable in a radial direction relative to the auxiliary handle axis, and
an actuator operable to move the pin between the retracted position and the extended position,
wherein the ball is receivable within a groove of the housing to couple the auxiliary handle to the power tool when the pin is in the retracted position.
